(19) United States
(12) Patent Application Publication
(10) Pub. No.: US 2024/0394404 A1
(43) Pub. Date: Nov. 28, 2024

(54) SECURITY AND CONTROL PLATFORM FOR INTERCEPTING, INSPECTING, AND SELECTIVELY ALLOWING INTERACTION WITH THIRD PARTY ARTIFICIAL INTELLIGENCE SERVICE PROVIDERS

(71) Applicant: Backplain Inc., Carlsbad, CA (US)

(72) Inventors: TIM O'NEAL, Carlsbad, CA (US); REED ANDERSON, Park City, UT (US)

(21) Appl. No.: 18/671,799

(22) Filed: May 22, 2024

Related U.S. Application Data
(60) Provisional application No. 63/468,517, filed on May 23, 2023.

(51) Int. Cl. G06F 21/62; G06F 21/60

(52) U.S. Cl. CPC G06F 21/6245; G06F 21/604; G06F 2221/2141

(57) ABSTRACT

Certain aspects of the disclosure provide systems and methods for securing and regulating user-AI interactions, an example method comprises receiving, by a message broker of a control platform, a user data prompt to at least one AI system; executing, by a secure layer of the control platform, a security control protocol on the user data prompt; based on the executing, generating, by the secure layer of the control platform, an approved data prompt; providing, via the message broker, the approved data prompt to the at least one AI system; receiving, by the message broker, a response to the approved data prompt from the at least one AI system; and providing, by the secure layer, the response to a user of the control platform.

### CROSS-REFERENCE TO RELATED APPLICATIONS

This application claims the benefit of and priority to U.S. Provisional Patent Application No. 63/468,517 filed on May 23, 2023, the entire contents of which are hereby incorporated by reference.

### BACKGROUND

### Field

Aspects of the present disclosure relate to the field of artificial intelligence (AI), organizational networks, enterprise systems, and interactions with AI service providers.

### Description of Related Art

Generative AI models are models that create new data based on prompts or prompt inputs that include public user queries and prompts into the AI models. These models can be differentiated from discriminative AI models that focus on classifying data by identifying decision boundaries between data. Generative AI models can generate text, images, audio, video and other content based on the type of data sets they are trained on. Users connect to these models through web or application interfaces and can input queries/prompts and request to interact with these AI models to generate answers or other content based on the query and type of model interacted with.

### SUMMARY

Certain aspects provide a method that secures and regulates interactions between user(s) and artificial intelligence (“AI”) systems (e.g., chatbots and generative AIs) where the method can include receiving by a control platform, a user data prompt or query directed to at least one AI system. The security and control platform may execute or run a security control protocol on the user data prompt. This can for example include scanning for sensitive information/data that should not be part of the prompt and should not be publicly disclosed; and based on this security protocol and/or results of its execution, the security and control platform can then generate an approved prompt, e.g., that has no sensitive or confidential information, that may then be provided, sent, or communicated to the AI system. The control platform would receive a response from the AI system and provide this response to the user or user device/account that initiated the prompt.

Certain aspects provide a processing system that comprises a memory and a processor, where executing instructions cause the processing system to receive a user data prompt or query that is intended for or directed to at least one recipient AI system or model. The processing system executes a security control protocol on the user data prompt or query and then based on this, the processing system may generate an approved data prompt or query (that for example may be scrubbed of sensitive information). The processing system can send, communicate, or provide the approved data prompt to the intended recipient AI system, receive a response to the approved data prompt from the at least one recipient AI system; and provide, the response to at least one account user of a control platform.

Certain aspects provide a non-transitory computer-readable medium (“CRM”), the CRM stores program code for causing a processing system to perform a method comprising connecting, a control platform to at least one recipient AI system or model; based on the connecting, monitoring real-time communication activity between the control platform and the at least one recipient AI model; receiving, e.g., by a message broker of a control platform, a user data prompt to the at least one recipient AI model; executing, by a secure layer of the control platform, a security control protocol on the user data prompt; based on the executing, generating, by the secure layer of the control platform, an approved data prompt; providing, via the message broker, the approved data prompt to the at least one recipient AI model/system; and receiving, by the message broker, a response to the approved data prompt from the at least one recipient AI system.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a diagrammatical representation of an operating ecosystem of a security and control platform (“control platform”), including its various software tools, modules, and components and the relationship to enterprise and AI systems, according to at least one aspect of the present disclosure.

FIG. 2 depicts an example of a user interface (“UI”) of the control platform, according to at least one aspect of the present disclosure.

FIG. 3 depicts another diagrammatical representation of the UI of the control platform, according to at least one aspect of the present disclosure.

FIG. 4 depicts a diagrammatical representation of a chat panel of the UI of the control platform, according to at least one aspect of the present disclosure.

FIG. 5 depicts a diagrammatical representation of a multi-chat panel of the UI of the control platform, according to at least one aspect of the present disclosure.

FIG. 6 depicts a diagrammatical representation of an alerts panel of the UI of the control platform, according to at least one aspect of the present disclosure.

FIG. 7 depicts a diagrammatical representation of a portion of the architecture of the control platform system with a focus on the relationship between an end user of an enterprise system and the control platform, according to at least one aspect of the present disclosure.

FIG. 8 depicts a diagrammatical representation of the architecture of the control platform with a focus on its secure layer, according to at least one aspect of the present disclosure.

FIG. 9 depicts a flow diagram of a method for creating policies and profiles for the control platform, according to at least one aspect of the present disclosure.

FIG. 10 depicts a flow diagram of a method for securing and regulating user-AI interactions.

FIG. 11 depicts another flow diagram of a method for securing and regulating user-AI interactions, by a control platform, according to at least one aspect of the present disclosure.

FIG. 12 is a diagrammatic representation of an example system that includes a host device within which a set of instructions to perform any one or more of the methodologies discussed herein may be executed, according to at least one aspect of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide devices, methods, processing systems, and computer-readable mediums for monitoring and regulating interactions with AI models and services.

Organizations face a new and emerging threat to secrecy and privacy caused by the rapid evolution and adoption of AI enabled tools that leverage a deep learning architecture. These types of AI are constantly “learning” so any data introduced to these systems is stored and the data could be re-used in determining a future response. Currently, a member of an organization could unintentionally introduce the organization's sensitive or confidential data to an AI that leverages a deep learning model, putting the organization's data at risk in the public domain discoverable by third parties.

Overwhelming adoption of AI-enabled chatbots, for example those based on Large language models (“LLM(s)”) that leverage deep learning, pose the potential to create significant security problems that organizations are unable to manage (these AI-enabled systems, AI models, third party AI services and chatbots are collectively and interchangeably referred to herein as “AI system(s)”). AI systems that are delivered to a user's web browser on an organization's secure endpoint allow for human-computer interactions (“HCl”) in secure environments that mimic human conversation or dialogue. This dialogue can include text, images, video, audio, or any other sensitive content capable of being transmitted from a user's endpoint (computer, phone, etc.) to the AI system.

While current conventional IT security systems, such as firewalls, can identify incoming and ongoing traffic to websites and applications that host external AI systems, traffic which is generally allowed to pass with no restrictions, current tools are unable to monitor, filter and control the nature or essence of this traffic, i.e., the nature or content of the dialogue/communication with AI systems. The content of the dialogue a user has with an AI system is lost forever by the organization and the enterprise system it runs. It is not stored or adequately managed, and to compound risk, the only place the dialogue is fully stored is with the third-party AI enabled system provider in their deep learning environment, which theoretically may be accessed not only by administrators of the AI system provider, but other public users interacting with the AI system.

There are no existing technological controls or technical solutions to prevent an organization's user from sharing sensitive information with AI systems or regulate that interaction in any way. In fact, most available web-based AI systems, like publicly available chatbots, do not offer even a fundamental level of enterprise-level user controls, let alone policy-driven protections. These systems allow an organization's user to sign-up independently of organization IT controls and all usage is invisible to the organization's teams. If a data leak were to happen, the organization is completely unaware.

At present, there are only two options available to an organization to manage risks from AI systems. The first is to entirely block all AI systems from user access, and the second is to train employees on the risks of interacting with AI systems and hope that they do not publish or input sensitive information to these AI models. Neither of these options are effective. There are too many new AI systems being released regularly and it is unlikely that an organization will be able to find and block them all. Also, these AI systems can be useful to enterprise users and completely banning them is not an effective business solution. It is also unrealistic to expect that a well-trained human user to never make a mistake and enter sensitive information.

There are no solutions available today that provide an organization with the ability to manage access to third party AI systems, monitor and record the content of the dialogue between the human user and the AI system and prevent sensitive or confidential information from being inadvertently leaked to an AI system.

The sheer number and types of AI models, and their availability to the public via the internet on mobile, web and hybrid interfaces make it impossible to detect and prevent improper user interactions. Furthermore, even if every possible AI model is detected and known, it is difficult for organizations to regulate user interactions with these models, since each interaction is largely governed by the platform that is being used to conduct it, for example a web browser, or mobile application. Administrators of enterprise systems would therefore be limited in monitoring and regulating such interactions between enterprise users and the third-party AI-models.

Disclosed herein are technologies that provide technical solutions including a collection of security and control platforms, tools and systems (herein referred to as “control platform”) to control the interaction between end-point users and third-party AI models. The technologies presented herein can include an aggregation hub of various approved AI models, and a specialized user interface, where the control platform can in some aspects act as a proxy between users and the approved AI models to regulate the interactions between them to ensure that confidential, sensitive, or private information is not input or published into the AI models. These technological solutions only allow interaction with approved AI models through a specialized security and control platform system and using methods that protect organizations' and enterprise data from the public domain.

Large scale business hardware and software systems and infrastructure (collectively referred to herein as “enterprise system(s)”) that organizations utilize to manage data, staff, documents, applications, and overall business activity can integrate or deploy the control platform disclosed herein, which allows administrators to select and add approved AI systems to the control platform. The control platform can aggregate these AI systems and allows users to interact with them via a specialized user-interface, while preventing access to other non-approved AI systems. The control platform then monitors in real-time (or near real-time) interactions with one or more approved AI systems, while implementing security policies and protocols and leveraging AI solutions to regulate and take actions to prevent or minimize the publication of sensitive information to the AI systems.

In several aspects the control platform is a suite of enterprise-grade tools that when combined become a control layer for an organization's or enterprise system's interaction with external AI models. The control platform allows AI model aggregation where administrators can add unlimited API-enabled publicly available, or privately hosted, AI models and chatbots to the control platform with a single interface from which to monitor, regulate, and control interactions for the entire organization. Where API connectivity to a third party is not possible, the control platform can utilize screen scrape and record functionality to monitor and regulate inputs/prompts to the AI systems.

In aspects, access to approved AI systems is maintained by the control platform's administrator and users will only be allowed to access configured and approved AI systems. Access to approved AI systems can be limited or partially limited by the administrator by using advanced intelligent masking and filtering algorithms that are generated from user and administrator's feedback.

In aspects, the proposed control platform integrates with common enterprise control systems for user management and provides a single manageable destination for users to interact with third party AI systems. The control platform provides search, logging, analytics, compliance, policy enforcement, usage guides, recommendations, and quality assurance. It further provides for API connectivity compatible with a broad number of communication protocols to public and private systems and offers an SDK for custom applications.

Once an AI system is connected to the control platform, the platform monitors activity in real time and provides active content filtering, masking, and blocking to assist organizations in preventing leakage of sensitive data.

The technical advantages of this control platform allow users of an enterprise system to securely access AI systems through a controlled interface and hub where users can interact with one or many AI systems simultaneously. This provides a collection of AI systems that a user may select from all from one pane or one interface.

Also, both ingress and egress data may be controlled, and therefore not only data inputs into the AI systems can be managed and regulated, but data output from those AI systems can also be controlled and regulated prior to it being presented to the user of the enterprise system.

Additionally, the control platform allows storage of interaction data between the user and the AI systems to create a knowledge base that can be used for training internal AI models that can further improve and automate the control platform.

Furthermore, because of the integration of the control platform with the enterprise system, security actions and responses may be deployed in response to specific interactions between users and AI systems. For example, users may be ranked or scored based on their interactions and have permissions, roles or security credentials revoked or adjusted based on the data they attempt to input into these AI systems. Notifications or alerts may be issued to users and administrators, and training of users may be improved and automated based on stored historic interaction data.

The technical advantages of the solutions presented provide real-time monitoring, regulating, controlling, and storing of user-AI interaction data and based on that data generating more real-time effective interactions with AI systems in a secure and controlled environment as created by the control platform.

Further technical advantages include and are not limited to having a secure interaction environment that allows aggregation and a secure connection to multiple AI systems and to simultaneously control and regulate user interactions with these systems in real-time.

### Example Systems and Methods

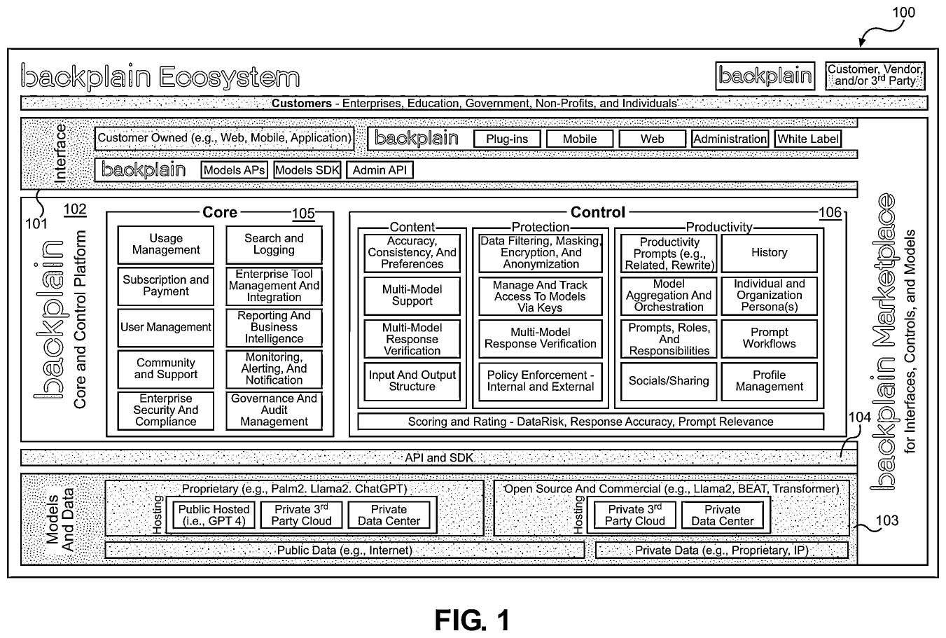

FIG. 1 depicts a diagrammatical representation of an operating ecosystem of the control platform including its various software tools, modules, and components and the relationship to enterprise and AI systems, according to at least one aspect of the present disclosure. FIG. 1 illustrates the control platform ecosystem 100, which may include an interface layer 101, core and control modules 102 of the control platform, and the APIs and SDKs 104 that connect to models or data 103 (i.e., third-party AI systems). In several embodiments, the control platform may be implemented in the cloud as a multi-tenant system. For more sensitive and secure environments, the control platform can be delivered as an appliance to be used on-premises in closed systems.

The interface layer 101 of the control platform ecosystem 100 can include web, mobile, or application interfaces that are used by customers or users of an enterprise system to access the control platform. The interface layer 101 may also include customer APIs and SDKs that can be used by customers or enterprises to build custom interfaces to interact with the control platform if they wish to customize their experience.

The core and control modules 102 represent the components and suit of functionalities that make up the control platform. In aspects, the core and control modules may be grouped as core modules 105 and control modules 106 of the control platform, where the core modules may include modules and software packages for usage management, subscriptions and payments, user management, community and support, enterprise security and compliance, search and logging, enterprise tool management and integration, reporting and business intelligence, monitoring alerting and notification, and governance and audit management.

The control modules 106 may include modules and software packages falling into three module/packages groupings: content, protection and productivity, these groupings representing the active part of managing interactions between users and AI systems and help the enterprise system become more efficient with utilization of the control platform. The controls module 106 manages the input and output of content to the internal AI models for accuracy, consistencies, and references based on profiles and profile settings (also referred to as “personas”). The protection within the control management handles data filtering, masking, encryption, and anonymization via the profiles. Lastly, productivity controls enable users and organizations to manage prompts and personas/profiles.

Content packages of the control modules 106 grouping support accuracy, consistency and references, for example requiring AI systems to provide citations and references as part of their responses. These may also include multi-modal support modules, multi-modal response verification, and input and output structure modules. The protection packages in the control module 106 may include data filtering, masking, encryption and anonymization packages, packages for managing and tracking access to AI models via keys, security packages, including prompt analysis and manipulation, as well as policy enforcement packages for internal and external policies.

The productivity group of packages of the control modules 106 can include productivity prompts, e.g., prompts for related queries or information to request or input into an AI system. This group of packages can also include model aggregation and orchestration, prompts, roles, and responsibilities (i.e., packages for implementing user roles and profiles), social and sharing packages to share information and results, history modules (tracking history of queries submitted and/or results obtained across various AI systems), individual and organization persona(s) or profiles (setting and adjusting user/group roles, permissions, settings and profiles), prompt workflow packages, and profile management modules.

The control platform ecosystem 100 also includes the models and data 103 connected to the control platform. The models and data 103 can include both publicly available AI systems and models and the data they use, as well as private/proprietary AI systems and models and their data. Both public and proprietary AI and data systems can connect to the control platform and form a part of the control platform ecosystem 100. Interactions between the control platform and these various types of AI systems can occur via APIs and/or SDKs 104, which may be provided by the vendors of the AI system or custom built to integrate with the control platform. Various proprietary AI systems build a LLM on proprietary data to create their own AI systems that can then be connected to the control platform.

### User Interface

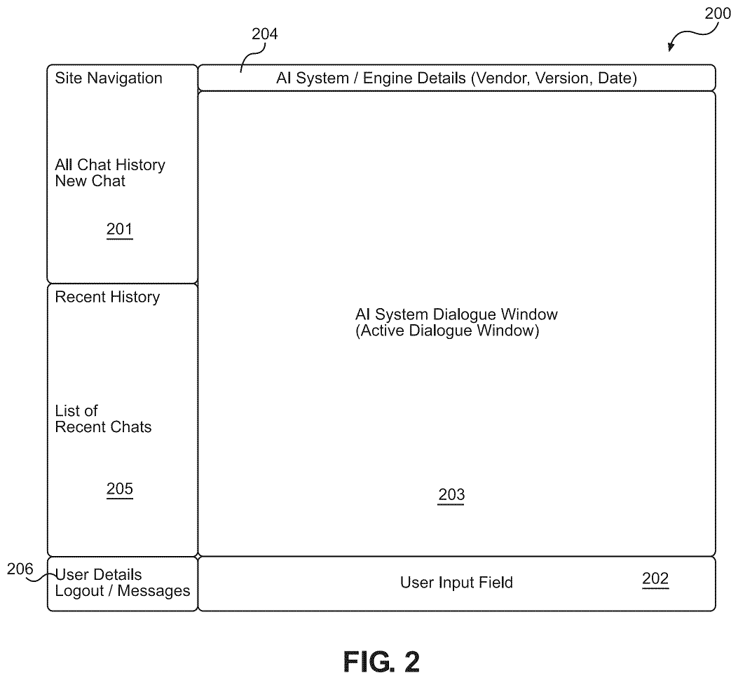

FIG. 2 depicts a graphical representation of a UI of the control platform, according to at least one aspect of the present disclosure. UI 200 can include a site navigation section 201, which may include tabs or links to chat history with one or more AI systems, or interactive interfaces to initiate a new chat with an AI system.

A user input field 202 may be used as an interaction dialogue input area. A user may type text (chat) or drag and drop files, including audio and video files, into the user input field 202 to initiate chat or interaction with an AI system. The AI system dialogue window 203 of the UI 200 displays results of interactions with AI systems, for example responses of the AI systems to user queries. User input may be followed by a system response displayed on AI system dialogue window 203. If a file is presented as part of an output, download options will be presented in AI system dialogue window 203. Finally, UI 200 may include an AI system dialogue window 203 section, for example this may display details on the AI system/engine with which the user is interacting.

UI 200 can also include a recent history section 205 with a list of recent chats with AI systems. Clicking on this section may allow selection of an approved AI system to begin dialogue or use of that AI system. UI 200 can include an interactive user menu 206 that includes administrator access, messages, logout, and access to the account, as well as user details, messages, and a log out function.

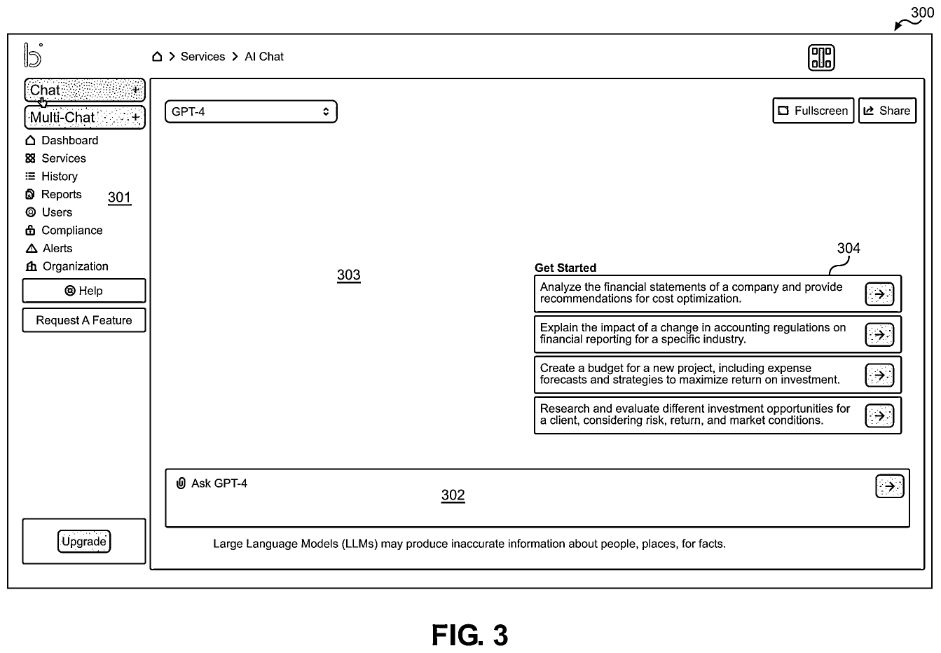

FIG. 3 depicts another graphical representation of the UI of the control platform, according to at least one aspect of the present disclosure. FIG. 3 presents UI 300 which includes a site navigation section 301, a user input field 302 that may be used as an interaction dialogue input area to an AI system, and an AI system dialogue window 303 that displays results of interactions with AI systems, for example responses of those AI systems to user queries.

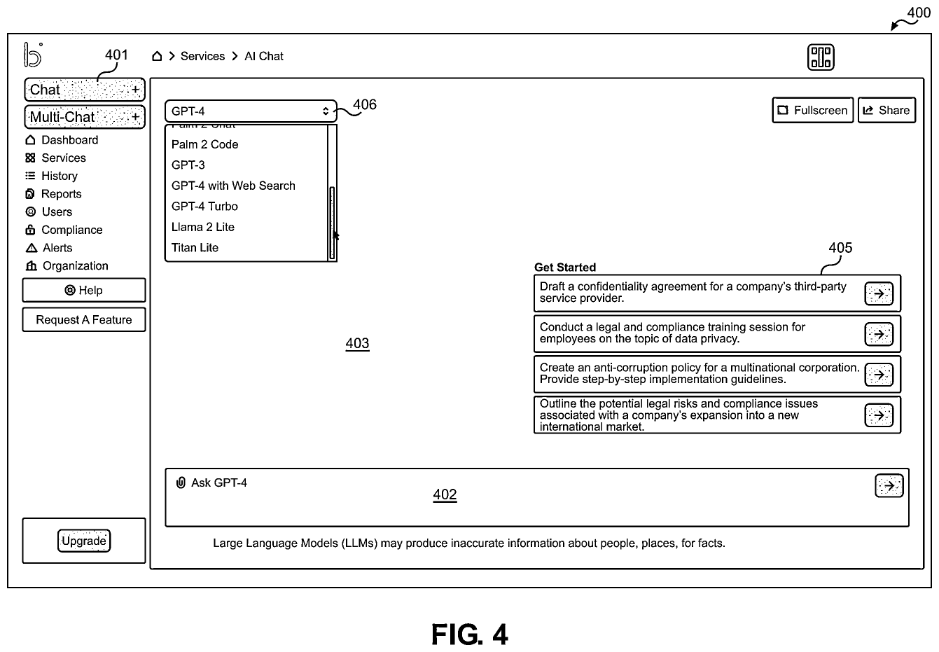

FIG. 4 depicts a graphical representation of a chat panel of the control platform UI, according to at least one aspect of the present disclosure. In chat panel 400, a chat button or interactive portion 401 can be clicked or selected to initiate a chat with an AI system. An AI system can be selected from selection button or dropdown 406 which lists the AI systems connected or integrated with the control platform. Chat panel 400 can also include a user input field 402 that may be used as an interaction dialogue input area to an AI system, and an AI system dialogue window 403 displays results of interactions with AI systems. Chat panel 400 can also include smart and/or dynamic suggestions or prompts 405 that may be driven by internal AI models of the control platform.

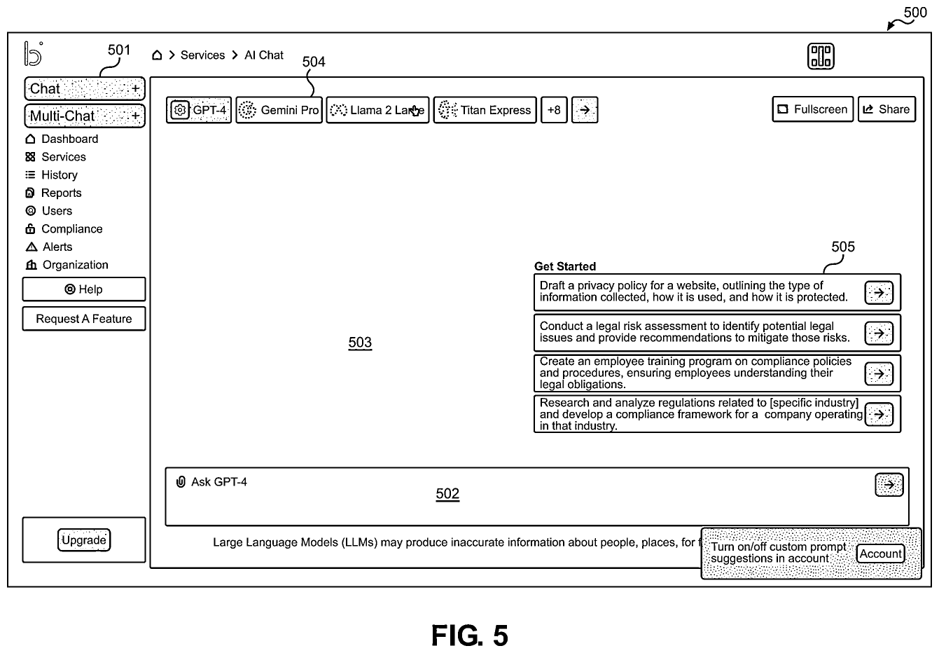

FIG. 5 depicts a graphical representation of a multi-chat panel of the control platform UI, according to at least one aspect of the present disclosure. In multi-chat panel 500, a chat button or interactive portion 501 can be clicked or selected to initiate a chat with a selection of multiple AI systems via multi-AI panel 504. The multi-chat panel 500 can display results from multiple AI systems simultaneously, in AI system dialogue window 503. A user can choose which AI system results to display by selecting the active AI system from multi-AI panel 504. The multi-chat panel 500 can also include a user input field 502 that may be used as an interaction dialogue input area to the multiple AI systems. Multi-chat panel 500 can also include smart and/or dynamic suggestions or prompts 505 that may be driven by internal AI models of the control platform.

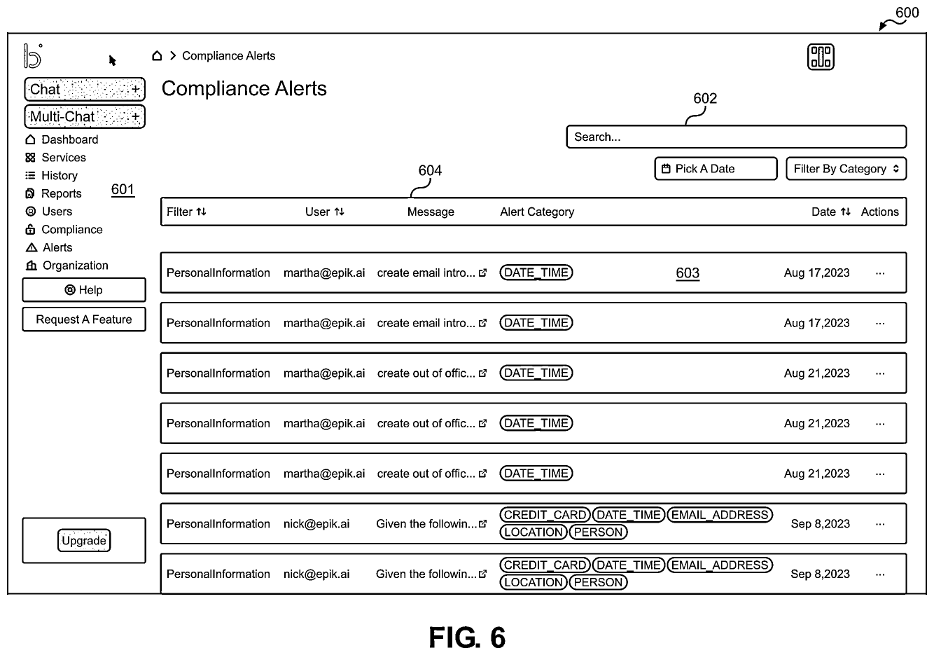

FIG. 6 depicts a diagrammatical representation of an alerts panel of the control platform UI, according to at least one aspect of the present disclosure. Alerts panel 600 includes a site navigation section 601, a search bar 602 which allows users to search for specific queries, types of queries, users, message text or content, dates, actions and alerts and any other data related to the alerts panel 600. Individual alerts 603 may be listed, and may be organized based on the header row 604. The control platform's observability allows system administrators to visualize how AI systems are performing by comparing their response and performance from customized metrics and feedback from their users.

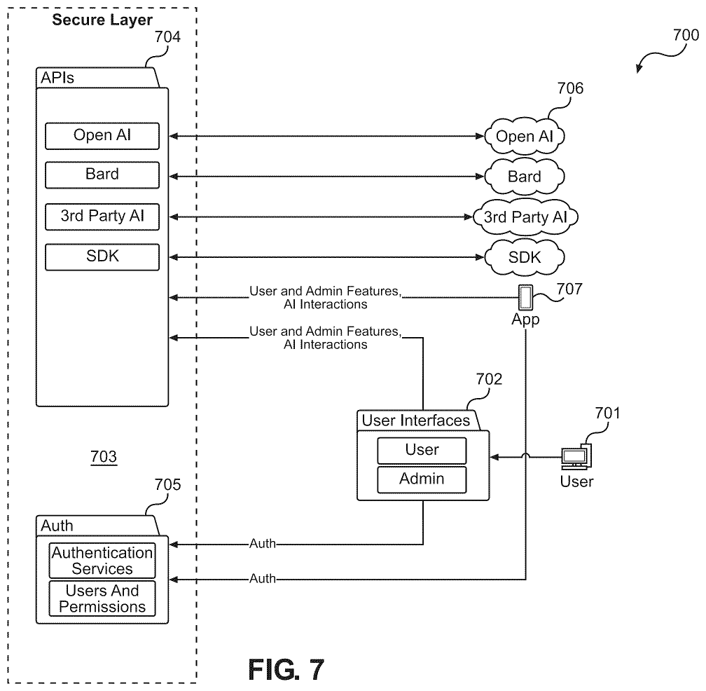

FIG. 7 depicts a diagrammatical representation of a portion of the architecture of the control platform system with a focus on the relationship between an end user of an enterprise system and the control platform, according to at least one aspect of the present disclosure. The connection component system architecture 700 (“connection component”), can include a user device/account 701 which along with application 707 can be used by users to connect to the control platform (the client device/account 701 and the application 707 can be referred to collectively and interchangeably herein as “user(s)” since they all represent users connecting to the control platform via one or more of a user account, user device, application, etc. These could be the same or different users/accounts/devices). Users 701, 707 may, depending on the embodiment, connect to user interfaces 702, for example the user interfaces of FIGS. 2-6. The user interfaces 702 can comprise different user interfaces for administrators and for users and may be different between user or client device/account 701 and application 707. The user interfaces 702 are then connected to a secure layer 703 of the control platform, which hosts APIs 704 and authentication module(s) 705. APIs 704 may be custom APIs designed specifically for each of the AI systems 706 that are approved and to which the control platform allows access. These AI systems 706 may be aggregated and presented to the user 701, 707 to use and connect with via the user interfaces 702. Users may also connect to the control platform and subsequently to the AI systems 706 via the secure layer 703 through an application 707, which may include web, mobile or hybrid applications, and which may have their own UI or connect directly to the APIs 704 to access the available and approved AI systems 706. The authentication module 705 of the control platform can authenticate users 701, 707 that connects to the secure layer of the control platform, and once authenticated allow the user access to interact with the AI systems 706 via the secure layer 703.

The control platform may aggregate multiple AI models and modalities, both public models (e.g., ChatGPT) and private models (i.e., models built for an organization using their own data). This allows the users 701, 707 to leverage whatever AI system 706 and modalities that they need and want. An administrator of an enterprise system deploying the control platform will have the ability to determine and set which AI systems are available to what roles, groups, or profiles. The control platform maintains user privacy in interactions with the AI systems 706. Data privacy does not only apply to the users' queries but also to any additional data included through processes such as retrieval augmented generation (“RAG”).

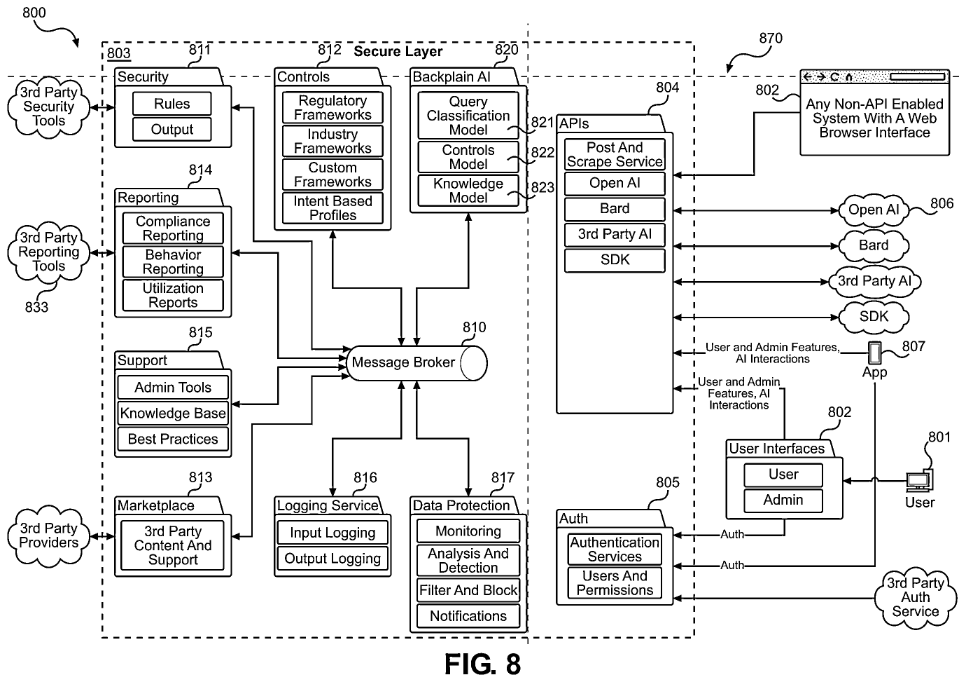

FIG. 8 depicts a diagrammatical representation of the architecture of the control platform with a focus on its secure layer, according to at least one aspect of the present disclosure. Control platform 800 includes connection component 870 which corresponds to the connection component 700 as described in FIG. 7. Control platform 800 also includes user device/account 801 (which together with application 807 are referred to collectively as “user(s)” corresponding to user(s) 701, 707, FIG. 7), user interfaces 802, APIs 804, authentication module 805, AI systems 806, all of which correspond to their counterparts in FIG. 7 and for brevity will not be discussed in detail.

In aspects, the control platform 800 includes secure layer 803, which comprises all the primary software packages or modules of the control platform 800, wherein each module is responsible for a set of actions or programmable instructions. The central module is message broker 810 which connects all the presented modules of the secure layer 803 together. The message broker 810 receives and sends communications/instructions to and from various sources and modules in the secure layer 830, and facilitates delivery of these communications/instructions to other sources or modules in the secure layer 830, and may translate or harmonize different communication protocols from different sources to enable such communications. The control platform 800 can include a security module 811 that comprises both rules for security protocols and outputs that implement the rules in specified situations/contexts. For example, an administrator may create rules or policies for roles and permissions of users, groups, different events or situations, or user/group profiles. These are governed and implemented by the security module 811. In one example, specific documents or information may be deemed sensitive or private in regard to specific users, groups or events or other category, or different security levels may be applied to different data or documents based on groups, policies, frameworks, profiles, roles as well as settings from other modules and their various rules and settings.

In numerous aspects, the control platform 800 further includes a controls module 812 that may set out and comprise policy documentation, policy regulations, rules, and frameworks. For example, rules based on the Health Insurance Portability and Accountability Act of 1996 (HIIPA) or other industry regulations and laws may be added to the control platform 800, manually, e.g., by an administrator or automatically, where these regulatory frameworks and policies may be pulled from various sources or data feeds. These rules may include both public and private policies that are implemented and applied to the data communicated between users, groups and information via the control platform 800 and the AI system(s) 806.

A marketplace module 813 may provide the user of the control platform 800, in aspects, options to download additional modules, tools and support applications to improve their control platform 800 experience. These may be proprietary or third-party tools, 833. Reporting module 814 can implement and execute reporting of information to various departments, users, groups, or services of an enterprise system. These could include compliance reports, behavior reports, and utilization reports of users using the control platform 800. Many of this data can be collated, processed, and presented to administrators or internal AI models to govern the behavior of users or otherwise improve the control platform 800.

The control platform 800 may also include a support module 815 which comprises administrator tools, a knowledge base, and best practices policies. In aspects, the control platform 800 comprises a logging service 816 which logs inputs/prompts of users of the control platform 800 as well as outputs from users 801, 807 and/or the AI system(s) 806. Data may be protected via a data protection module 817 which undertakes live monitoring and analysis of inputs/prompts of users 801, 807 and/or the AI system 806 outputs, and detects private or sensitive information in conjunction with one or more of the various modules in the secure layer 803, and facilitated by the message broker 810 that can act as an intermediary. The data protection module 817 can also implement data filtering, blocking, masking, anonymization, and replacing of sensitive or private data with non-sensitive data. These protective actions can be undertaken by the data protection module 817 based on the aforementioned groupings, policies, frameworks, profiles, roles as set by the various other modules and their configured rules and settings. Users 801, 807, may, in some aspects, be provided with real-time feedback that is triggered from interactions with the AI system(s) 806, where the data protection module 817 can automatically block, mask automatically, or provide suggested prompts for live interactions with the AI system(s) 806 and/or provide notifications or alerts to the organization administrator or a user with a specific profile. Such feedback and triggered actions/rules can be based on pre-set models custom generated for the organization and/or configured by the administrators.

In aspects the control platform 800 also includes internal AI module 820. In aspects, the internal AI module 820 can comprise one or more internal AI models 821-823 that may include any combination of a control AI model 821, a query AI model 822, and a knowledge AI model 823. The internal AI module allows the control platform 800 to control, regulate, and automatically protect sensitive information in inputs and queries in real-time and support all the other modules of the secure layer 803. The control platform 800 can utilize the internal AI modules 820 to detect, stop, or mask information being sent to stop a possible information breach from the organization to a third-party AI model.

The control AI model 821 performs input and output data validation as well as profile creation and improvement. The control AI model 821 may use specific workflows and parameters to validate input and/or output data by using pattern detection, keyword search, and cross engine validation via profiles set by other modules. These parameters are configurable to include data protection, compliance, and IT security checks as well. The control AI model 821 provides go-live gating and assesses the reliability and security of AI-generated code to ensure compliance with the various modules in the secure layer 803. For example, for code checking, the control AI model 821 integrates code validation and security tools (e.g., Dynamic Application Security Testing).

The query AI model 822 classifies queries and prompts based on intent. It works in conjunction with the control AI model 821. It performs clustering and classification on keywords. The query AI model 822 uses the prompt classifications as a way to group metrics so that an organization can understand how the different AI system(s) 806 are being utilized. It can be used by enterprise systems that want to limit the use cases that AI system(s) 806 get used or are available to the users 801, 807. The query AI model 822 uses an artificial intelligence approach to creating a representation of the prompts bring used as input to the AI systems 806. The query AI model 822 also makes use of embedding endpoints to generate the embedding that will be fed into the model for classifications.

The knowledge AI model 823 uses large language model document embedding as an index to company proprietary information that can be used for search/retrieval so the information can be included as context when prompting the AI system(s) 806. The model uses embedding of an enterprise system's knowledge base documents to enable different features that customize interactions to the organization of the user 801, 807. This automatically added context from the knowledge base to prompts and will result in organization specific answers. This feature is usually enabled for engines with profiles that align with the organization's security profiles. In cases where the AI model does not align with the organization's security profiles, but does provide value and is made available to users, it can use the knowledge base to know if the user query/input/prompt contains secrets/sensitive information and filter the user prompt before it gets to the AI systems 806. This model interfaces directly with the controls module 812 to inform profiles, roles, or personas.

In an example implementation aspect of the control platform 800 and its various modules, all interactions with AI systems 806 are monitored real-time, e.g., by the data protection module 817, and if a profile (e.g., set by an administrator via the security module 811) is triggered, or has certain limitations in terms of data protection (what they can and cannot share), then content may be blocked or masked by the data protection module 817 according to the limitations set for the profile, via the message broker 810, from being sent to the AI system 806, and a message will be presented to the user by the data protection module 817, based on best practices set in the support module 815 and the rules of the security module 811 regarding the event. Administrators may also receive a notification, also based on the aforementioned modules and depending on the severity of the event. Reporting is provided to administrators and users with roles that require the ability to search and review interaction histories, e.g., as set by the security module 811.

In example aspects, upon detection of sensitive data (e.g. customer personal identifiable information (“PII”), or IP address in app logs, etc.) in a prompt, the control platform 800 can replace the sensitive information in the prompt in a way that maintains semantic meaning, but without identifiable information. The sanitized input/prompt is sent to the selected AI system 806, and the response from the AI system 806 will be sent back to the control platform 800 to be processed before finally being presented to the user 801, 807. During optional post processing, original sensitive data is introduced into the response based on the replacements made in the sanitized prompt. In one example, when sensitive data is detected in a prompt it is sorted into the entities that are referenced in the prompt. Then the control platform generates artificial entities of the same type as the detected data and replaces the references to sensitive data in the prompt with the attributes of the generated entities. These entities of the same type may be provided by one or more of the various modules in the control platform. This process removes the identifiable information in the prompt but maintains the same semantic meaning.

The third-party tools 833 can in aspects be plugged in or integrated with any of the modules, depending on the specific configuration of the control platform 800

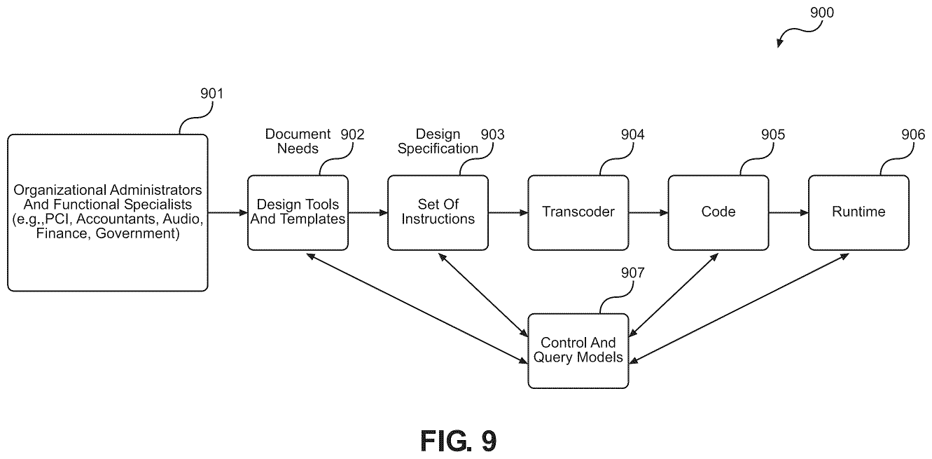

FIG. 9 depicts a flow diagram of a method for creating policies and profiles for the control platform, according to at least one aspect of the present disclosure. The method 900 can include design software and templates being used by specialists to document 902 intent. Then creating 903 sets of instructions that comprise a detailed specification of functionality that describes a final product (e.g., profile(s)/persona(s)). The method 900 can also include relying on transcoding 904 via a transcoder, i.e., a translation tool that turns the detailed specification into actual code. The code is generated 905 as the final output of the transcoding 904. The code can then be executed 906 at runtime by modules of the control platform. All of these various processes may be governed and controlled 907 by control and query internal AI models to ensure their quality and accuracy.

An enterprise system's administrators and/or functional specialists can create and manage intent-based artifacts/templates for various profiles (e.g., prompts, code, regulatory frameworks (such as PCI, HIPPA, and IEEE), finance, and controlled and/or classified organization information). These artifacts are created using tools and templates that capture the creator's intent and it is transformed into a structured state. These intent-based artifacts/templates may be provided with pre-configured artifacts, and may also be simultaneously created via the control platform's tools/modules. The result generated is a set of instructions, which are then transcoded and applied at run-time against the selected external AI systems' ingress and egress data. This set of human-generated instructions is also passed into the control platform's internal AI models (e.g., 812-823 of FIG. 8) if requested by an administrator. The control platform internal AI model(s) of the AI internal module (e.g., 820 of FIG. 8), will then leverage the learnings to improve the profile in real-time or via notifications and recommendations to the administrators.

Various profiles, roles, and personas can be created by an enterprise system that is deploying the control platform. An administrator can define data categories via profiles from within an administrator interface. The control platform offers various possible profiles for various types of frameworks including regulations, compliance (e.g., FTC, SOX, HIPPA, PCI, ISO, IEEE, and COBIT), usage policies, user profiles, and industry security policies (e.g., healthcare, legal, finance, automotive, software).

These profiles can be applied or customized by an administrator to various user data inputs (referred to herein as “user data prompt”) to external AI systems. These profiles can be both static and/or dynamic. The dynamic profiles use dynamic templates able to learn from data in the control platform using a control platform learning engine. The learnings are surfaced through visibly to users via notifications and recommendations. The dynamic profiles utilize the data around how the user interacts with the platform (e.g., prompt intent, types of files uploaded, other profile details) to decide which recommendations and notifications to surface. The objective of the dynamic profiles would be to provide the end user with an optimized interface that streamlines the user experience based on the way they have interacted with the platform in the past.

The control platform provides various security functionalities (e.g., deny, lists, allow lists, keyword filters), as well as more advanced features for flagged AI systems. For example, the control platform may flag and notify users of types of content generated by an AI system as determined by the profiles. The control platform also offers and generates security profiles for various types of network devices (e.g., firewalls, IPS, IDS). For example, the control platform can generate an XML lists of rules sets for implementation on a firewall. Historical logging of prompt and output/response data to and from the AI systems is another functionality that allows sensitive information to be reviewed, traced and then masked or blocked from further use.

The control platform provides the ability of the users to obfuscate and/or anonymize prompt requests to protect the organization by deploying profiles. It uses large language model document embedding as an index to enterprise system proprietary information that can be used as a content filter for outgoing requests/user data prompts to external AI systems. The control platform uses data derived from categories of user prompt data, obtained from historical logging of such data, to restrict the AI systems from being used in certain ways depending on the context (e.g., when it is expensive to run highly specialized models, the implemented profile(s) could restrict the available categories of queries to users).

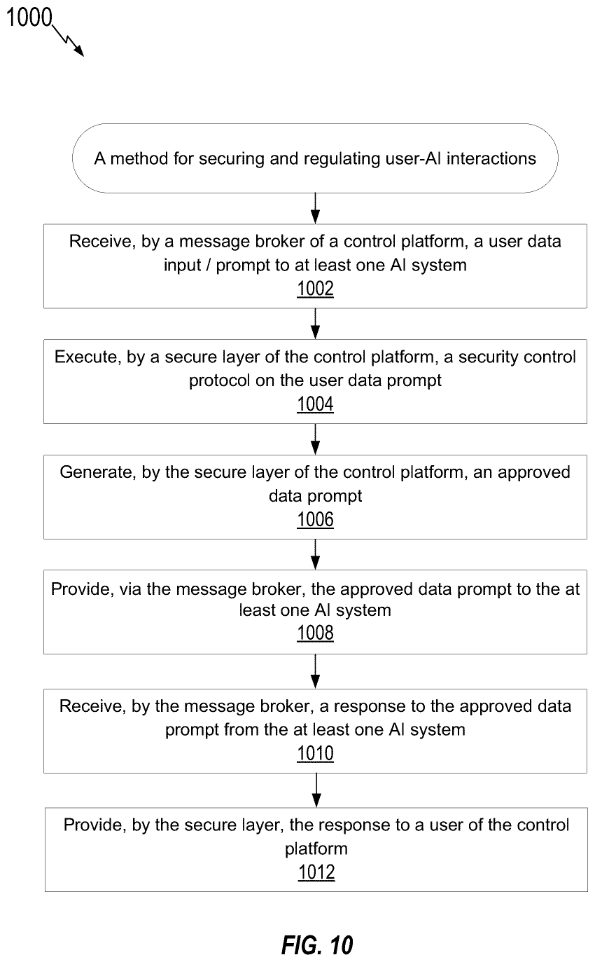

FIG. 10 depicts a flow diagram of a method for securing and regulating user-AI interactions. FIG. 10 will be discussed in combination with FIG. 8.

Method 1000 begins at 1002 with receiving, by a message broker 810, of a control platform 800, a user data prompt to at least one AI system 806. In aspects, the message broker 810 may receive the user data prompt via the user interface 802 from the user 801, 807 and expose the user data prompt to one or more other modules in the secure layer 803. For example, the data protection module 817 may monitor and analyze the received user data prompt in real-time as the user data prompt is received 1002 by the message broker 810 by continuously monitoring the data received by the message broker 810.

Method 1000 then proceeds to executing 1004, by a secure layer 803 of the control platform, a security control protocol on the user data prompt. For example, the security module 811 may apply profiles or rules on the user 801, 807 which are then applied to the user data prompt received by the message broker 810. For example, a user in the credit department may not be allowed to access specific AI systems 806, or prompt specific details, such as addresses. These rules may be set by an administrator in the security module 811, but may be applied by another module in the secure layer 803, e.g., by the data protection module 817. All of these interactions may be facilitated by the message broker 810 that connects the various modules of the secure layer 803. Likewise, the controls module 812 may set any policies or regulatory frameworks relevant to the user role, persona, group or profile or policies relevant to the enterprise/organization. These profiles or settings may be applied by the controls module 812 or by another module such as the data protection module 817. Executing a security protocol provides technical advantages such as

In aspects, the executing 1004 of the security control protocol comprises applying, by a data protection module 817, of the secure layer 803, connected to the message broker 810, a data filtering scheme on the user data prompt. In aspects, the executing 1004 of the security control protocol comprises classifying at least a portion of the user data prompt as sensitive, for example by the data protection module 817. While in aspects of method 1000, the executing 1004 of the security control protocol comprises running at least one internal AI model of the internal AI module 820, of the secure layer 803, connected to the message broker 810, on the user data prompt. The running of the internal AI model(s) 821-823, can include dynamically classifying the user data prompt, and checking/validating the user prompt against policies or personas as implemented by other modules such as the security module 811 and/or the control module 812, and can include assuring quality of the results of other modules such as the data protection module 817.

Method 1000 also comprises generating 1006, by the secure layer 803 of the control platform 800, an approved data prompt. The approved data prompt may be generated 1006 prompt based on the user data prompt being subjected to the executing 1004 of the security protocols, e.g., rules and policies from the executing 1004 are applied to determine what is approved or acceptable according to the security protocol rules/policies and then by applying these and other protocols generating another text that complies with the security protocol, the text being an approved version of the original user data prompt. The generating 1006 may be undertaken, in aspects, by the data protection module 817. In aspects the generating 1006 of the approved data prompt comprises at least one of blocking a portion of the user data prompt, filtering a portion of the user data prompt, masking a portion of the user data prompt, replacing at least a portion of the user data prompt with other data, or maintaining the user data prompt, for example because it complies with the security protocol and requirements executed 1004 on it. In aspects, the generating 1006 may include one or more of the processes of the executing 1004.

Method 1000 comprises providing 1008, via the message broker 810, the approved data prompt to the at least one AI system 806. After the control platform 800 has generated 1006 the approved data prompt, this approved data prompt/query can be input, fed, or submitted into the third-party AI system(s), e.g., the intended recipient AI system(s) 806, to receive a response from these AI system(s) 806. Once the AI system(s) 806 communicate or send a response back to the control platform 800, method 1000 includes receiving 1010, by the message broker 810, a response to the data output from the at least one AI system 806. Thus, not only is the user data prompt captured, but the AI system 806 response is also captured by the message broker 810, and this response can be exposed to the various modules of the secure layer 803 of the control platform 800, for example via the message broker 810. The various modules can implement or apply policies or rules based on the profile/persona, type of query, or the response received 1010 to determine what can/should be displayed or presented to the user. For example, if an AI system 806 generates hyperlinks to external websites, then specific rules may be triggered, e.g., by the security module 811 that may dictate that hyperlinks cannot be presented to the involved user based on their profile, and therefore another module such as the data protection module 817 may delete or mask or otherwise make unclickable any links to external websites presented to the user.

Furthermore, the method 1000 includes providing 1012, by the secure layer, the response to a user of the control platform 800. This can include displaying the result via the user interfaces 802 on a display device to the user 801, 807. Or it can include reading out or playing audio, video, or other content files.

In aspects, the method 1000 can also comprise connecting the control platform 800 to one or more AI systems 806, for example via APIs and/or custom software development kits (“SDK”). Once connected, real-time monitoring of each of the one or more connected AI systems 806 may be initiated, including monitoring real-time communication activity between the control platform 800 and the one or more AI systems 806, e.g., by monitoring the message broker 810. Method 1000 can also include aggregating the various connected AI systems 806 into a hub or user interface(s) 802, and presenting (for example by displaying on a display device via the user interface(s) 802) the one or more connected and monitored AI systems as an interactive options, where a user 801, 807 of the control platform 800 may interact with the selected AI system(s) triggering the various aforementioned processes of method 1000 and control platform 800. By connecting the control platform to an AI system via APIs and the other disclosed methods and creating an aggregation hub of various approved AI systems, data ingress and egress to AI systems can be controlled, manipulated, and displayed on a specialized user interface, allowing users to navigate between approved suggested prompts, answers, and between different AI systems. Data including user prompt data and AI system response data can be automatically transformed, controlled, and displayed on devices in a manner that is most relevant to each user.

Prompts are transformed into approved data prompts. Or approved data prompts are generated based on policies, data and information specific to each organization. This customizability allows the control platform to act as a personalized or custom security interface for each organization.

Communication and historical data of user-AI system interactions can also be stored and used for training internal AI modules and models to further improve communications with AI systems. The training of specialized internal AI models, will lead to more effective and efficient resource use by the enterprise system utilizing the control platform. For example, internal AI models may learn what questions/prompts and results each type of user or group of users (for example based on profiles or personas) would most benefit from using various software modules technologies herein allow aggregation of data and suggest these prompts or results, leading to less bandwidth usage, or less processing power. The system may also redirect prompts or queries to the AI system that is most relevant or identified as the more effective reaching desired results faster and with less processing or use of enterprise computing resources than would otherwise be the case. In various examples, results can be saved in databases with approved AI system responses, these approved responses may be saved and fetched instead of going to the AI systems for every query. This improves response time as well as eliminated inessential processing with repeated queries and repeated security protocol execution on each individual prompt/query.

Note that FIG. 10 is just one example of a method, and other methods including fewer, additional, or alternative steps are possible consistent with this disclosure.

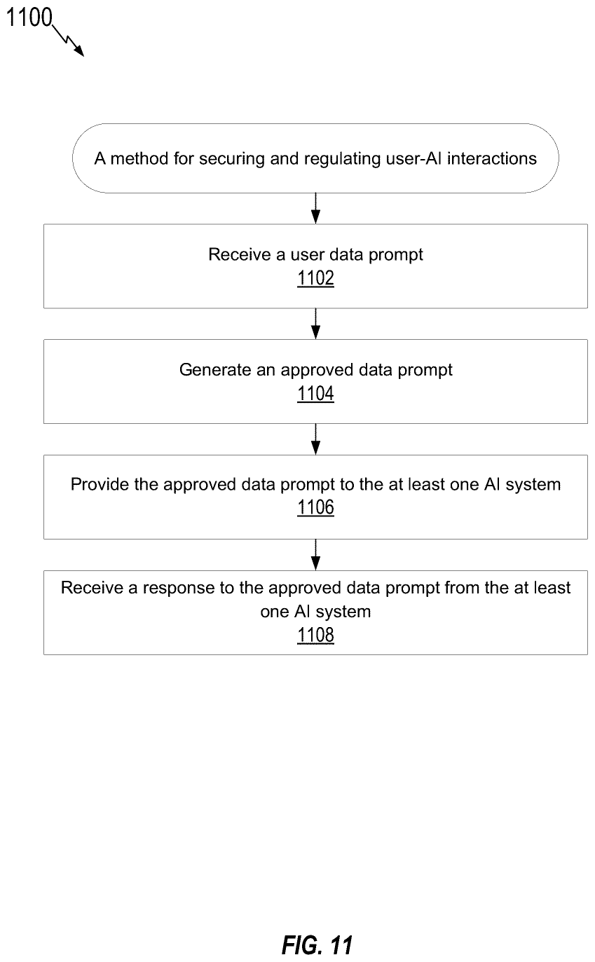

FIG. 11 depicts another flow diagram of a method for securing and regulating user-AI interactions by a control platform, according to at least one aspect of the present disclosure. Method 1100 includes receiving 1102 a user data prompt, for example, from a user to a control platform to query or prompt an AI system through the control platform.

The Method 1100 also includes generating 1104 an approved data prompt, which may include a transformed, filtered, masked, or partially blocked data prompt. The generating 1104 may also include maintaining the same data as the user data prompt. The generating 1104 can in aspects include applying preset profiles and security protocols, permissions or roles to the user data prompt, and may include utilization of internal AI models to apply rules and policies on the user data prompt. The generating 1104 may generate the approved data prompt based on these considerations and executable processes.

The method 1100 also includes providing 1106, for example by transmitting, feeding, inputting, or sending the approved data prompt to at least one AI system, and receiving 1108 a response to the approved data prompt from the at least one AI system.

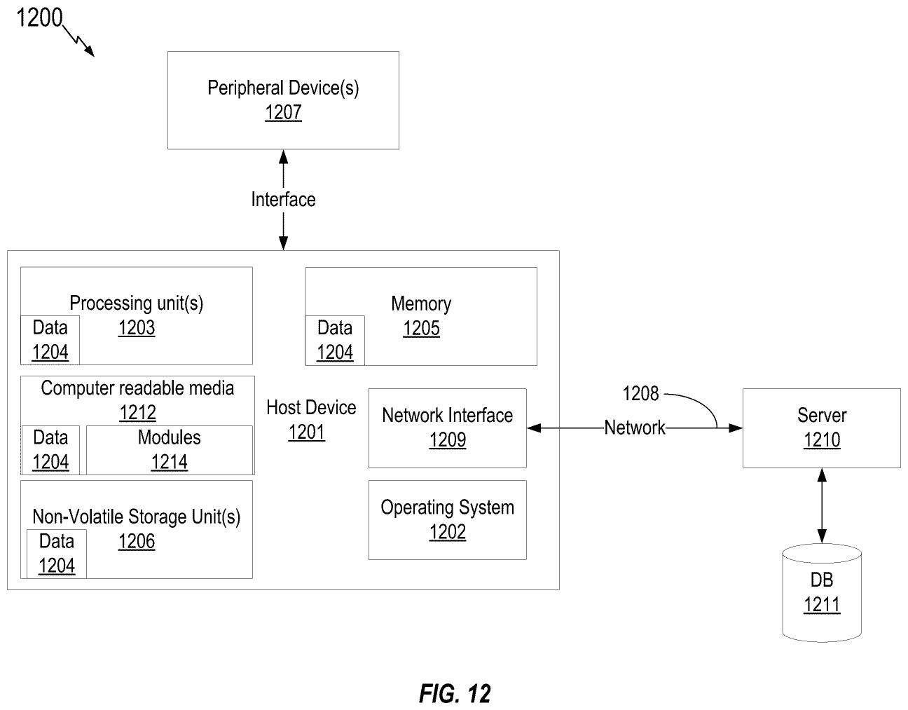

FIG. 12 is a diagrammatic representation of an example system 1200 that includes a host device 1201 within which a set of instructions to perform any one or more of the methodologies discussed herein may be executed, according to at least one aspect of the present disclosure. The host device 1201 as represented herein may refer to one or more host devices 1201, collectively and interchangeably referred to herein as “host device 1201.” In aspects, the host device 1201 operates as a standalone device or may be connected (e.g., networked) to other machines or devices. In a networked deployment, the host device 1201 may operate in the capacity of a server or a client device in a server-client network environment, as a peer device in a peer-to-peer (or distributed) network environment, or a node in a network environment. Examples of the host device 1201 can include and are not limited to a computer or computing device, a personal computer (“PC”), a smart device (that can include a phone, tablet computer, watch, virtual or augmented reality headset, or audio device), an internet-of-things (“IoT”) device, a set-top box (“STB”), a personal digital assistant (“PDA”), a cellular telephone, a portable music player (e.g., a portable hard drive audio device such as an Moving Picture Experts Group Audio Layer 3 (“MP3”) player), a web appliance, a network router, switch or bridge, or any machine capable of executing a set of instructions (sequential or otherwise) that specify actions to be taken by that machine or device. Further, while only a single machine or device is illustrated, the terms “machine” and “device” shall also be taken to include any collection of machines or devices that individually or jointly execute a set (or multiple sets) of instructions to perform any one or more of the methodologies discussed herein.

The example system 1200 includes the host device 1201, running a host operating system (“OS”) 1202 via processing unit(s) 1203 that may include a single or multiple processor/processor cores (e.g., a central processing unit (“CPU”), a graphics processing unit (“GPU”), or both). Processing unit(s) 1203 may also retrieve, receive, and/or execute instructions or data 1204 from memory 1205.

The host device 1201 can include non-volatile storage unit(s) 1206, for example, a disk drive unit including one that may be a Solid-state Drive (“SSD”), a hard disk drive (“HDD”), embedded MultiMediaCard (“e.MMC”), and Universal Flash Storage (“UFS”), or other computer or machine-readable medium on which is stored one or more sets of instructions and data structures (e.g., the data 1204) embodying or utilizing any one or more of the methodologies or functions described herein. The data 1204 may also reside, completely or at least partially, within the memory 1205 and/or within the processing unit(s) 1203 during execution thereof by the host device 1201. The processing unit(s) 1203, and memory 1205 may also comprise machine-readable media.

All the various components shown in host device 1201 may be connected with and to each other, or communicate to one another via a bus (not shown) or via other coupling or communication channels or mechanisms. The host device 1201 may further include or be coupled to one or more peripheral device(s) 1207. Non-limiting examples of peripheral device(s) 1207 can include a video display, an audio device, alphanumeric or other input device(s) (e.g., a keyboard, a cursor control device, a mouse, or a voice recognition or biometric verification unit), a connection or expansion hub, a signal generation device (e.g., a speaker,) or an external persistent storage device (such as an external disk drive unit). The host device 1201 may further include data encryption module(s) (not shown) to encrypt data, such as the data 1204.

The components provided in the host device 1201 are those typically found in computer systems that may be suitable for use with aspects of the present disclosure and are intended to represent a broad category of such computer components that are known in the art. Thus, the system 1200 can be a server, minicomputer, mainframe computer, or any other computer system. The computer may also include different bus configurations, networked platforms, multi-processor platforms, and the like. Various operating systems may be used by each of the various components of the system 1200 including UNIX, LINUX, WINDOWS, QNX ANDROID, IOS, CHROME, TIZEN, and other suitable operating systems. The aforementioned operating systems may or may not correspond with OS 1202.

The data 1204 may further be communicated over network 1208 via a network interface 1209 utilizing one or more well-known communication or transfer protocols (e.g., Hyper Text Transfer Protocol (“HTTP”)). The system 1200 may also include a server 1210. The server 1210 as represented herein may refer to one or more servers 1210, collectively and interchangeably referred to herein as “server 1210.” The host device 1201 can therefore communicate via the network 1208 to the server 1210 or to other nodes, endpoints, or servers that are not part of the system 1200. The server 1210 may be a database server, or may implement database solutions and/or may be connected to a database 1211 or other storage system that stores data and allows for efficient data management and retrieval by the server 1210. The database 1211 as represented herein may refer to one or more databases 1211, collectively and interchangeably referred to herein as “database 1211.” The database 1211 may be used to store data from the host device 1201 and/or the server 1210, including storing enterprise or organizational data, including user data, internal and third-party application data, and data collected from on-premises or cloud activity.

The host device 1201 may also include computer readable media 1212, able to store data or instructions 1204 and able to store the various modules 1214 that can undertake the various processes described herein. The modules 1214 may include and are not limited to a receiving module, an executing module, a generating module, a providing module that can undertake any of the processes described herein including those aspects in FIGS. 10-11, The term “computer-readable medium/media” or “machine-readable medium/media” as used herein may refer to a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions or data structures, e.g., data 1204, for execution by any device, including and not limited to the host device 1201 and which causes such devices to perform any one or more of the methodologies of the present application. Such media may also include, without limitation, all types of memory and storages, hard disks, floppy disks, flash memory cards, digital video disks, random access memory (“RAM”), read only memory (“ROM”), and the like. The example aspects described herein may be implemented in an operating environment comprising software installed on a computer, in hardware, or in a combination of software and hardware.

One skilled in the art will recognize that internet service may be configured to provide internet access to one or more host devices that are coupled to the internet service. Furthermore, those skilled in the art may appreciate that the internet service may be coupled to one or more databases, repositories, servers, and the like, which may be utilized to implement any of the aspects of the disclosure as described herein.

The computer program instructions, that may include for example data 1204, also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in presented flowchart(s) and/or block diagram block(s).

A network or networks as described herein, such as the network 1208, may include or interface with, as non-limiting examples, any one or more of, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SON ET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CODI (Copper Distributed Data Interface) connection. Furthermore, communications may also include links to any of a variety of wireless networks, including WAP (Wireless Application Protocol), GPRS (General packet Radio Service), GSM (Global System for Mobile Communication), CDMA (Code Division Multiple Access) or TOMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 1208 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers, which can include the server 1210. This network of web servers can therefore comprise a plurality of computing devices, such as the host device 1201, with the web servers, such as the server 1210 providing processor and/or storage resources. These web servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

Computer program code for carrying out operations for aspects of the present technology may be written in any combination of one or more programming languages, including an object-oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, e.g., the host device 1201, as a standalone software package, partly on the user's computer and partly on a remote computer or entirely on the remote computer or server, se the server 1210. In the latter scenario, the remote computer may be connected to the user's computer through any type of network as described herein or as known in the art.

### EXAMPLE CLAUSES

Implementation examples are described in the following numbered clauses:

Clause 1: A method for securing and regulating user-AI interactions, comprising: receiving, by a message broker of a control platform, a user data prompt to at least one AI system; executing, by a secure layer of the control platform, a security control protocol on the user data prompt; based on the executing, generating, by the secure layer of the control platform, an approved data prompt; providing, via the message broker, the approved data prompt to the at least one AI system; receiving, by the message broker, a response to the approved data prompt from the at least one AI system; and providing, by the secure layer, the response to a user of the control platform.

Clause 2: The method of Clause 1, wherein the executing of the security control protocol comprises applying, by a control module of the secure layer connected to the message broker, a data filtering scheme on the user data prompt.

Clause 3: The method of any one of Clauses 1-2, wherein the executing of the security control protocol comprises classifying at least a portion of the user data prompt as sensitive.

Clause 4: The method of any of Clauses 1-3, wherein the executing of the security control protocol comprises running at least one internal AI model of the secure layer, connected to the message broker, on the user data prompt.

Clause 5: The method of any of Clauses 1-4, wherein the at least one internal AI model comprises at least one of a control AI model, a knowledge AI model, or a query AI model.

Clause 6: The method of any of Clauses 1-5, wherein the generating of the approved data prompt comprises at least one of blocking a portion of the user data prompt, filtering a portion of the user data prompt, masking a portion of the user data prompt, replacing at least a portion of the user data prompt with other data, or maintaining the user data prompt.

Clause 7: The method of any of Clauses 1-6, wherein the providing of the response comprises displaying the response, via a user interface on a display device.

Clause 8: The method of any of Clauses 1-7 further comprising generating an actionable notification to at least one of an administrator account or user account.

Clause 9: The method of any of Clauses 1-8 further comprising connecting the control platform to the at least one AI system; based on the connecting, monitoring real-time communication activity between the control platform and the at least one AI system; and presenting the at least one AI system as an interactive option via a user interface.

Clause 10: The method of any of Clauses 1-9 wherein the connecting of the control platform to the at least one AI system is undertaken via at least one API.

Clause 11: A processing system, comprising: a memory comprising computer-executable instructions; and a processor configured to execute the computer-executable instructions and cause the processing system to: receive, a user data prompt to at least one AI system; execute, a security control protocol on the user data prompt; based on the execute, generate, an approved data prompt; provide, the approved data prompt into the at least one AI system; receive, a response to the approved data prompt from the at least one AI system; and provide, the response to at least one account user of a control platform.

Clause 12: The processing system of Clause 11, wherein the processor is further configured to cause the processing system to: connect the control platform to the at least one AI system; monitor real-time communication activity between the control platform and the at least one AI system; and display the at least one AI system as an interactive option via a user interface.

Clause 13: The processing system of any of Clauses 11-12, wherein the causing of the processing system to execute the security control protocol, comprises causing the processing system to apply a data filtering scheme on the user data prompt, classify at least a portion of the user data prompt as sensitive, or run at least one AI model on the user data prompt.

Clause 14: The processing system of any of Clauses 11-13, wherein the at least one AI model comprises at least one of a control AI model, a knowledge AI model, or a query AI model.

Clause 15: The processing system of any of Clauses 11-14, wherein the causing of the processing system to generate the approved data prompt, comprises causing the processing system to block a portion of the user data prompt, filter a portion of the user data prompt, mask a portion of the user data prompt, replace at least a portion of the user data prompt with other data, or maintain the user data prompt.

Clause 16: A non-transitory computer-readable medium, storing program code for causing a processing system to perform a method comprising: connecting, a control platform to at least one AI system; based on the connecting, monitoring real-time communication activity between the control platform and the at least one AI system; receiving, by a message broker of a control platform, a user data prompt to the at least one AI system; executing, by a secure layer of the control platform, a security control protocol on the user data prompt; based on the executing, generating, by the secure layer of the control platform, an approved data prompt; providing, via the message broker, the approved data prompt to the at least one AI system; and receiving, by the message broker, a response to the approved data prompt from the at least one AI system.

Clause 17: The non-transitory computer-readable medium of Clause 16, wherein the method further comprises: presenting the at least one AI system as an interactive option via a user interface.

Clause 18: The non-transitory computer-readable medium of any of Clauses 16-17, wherein the method further comprises: providing, by the control platform, the response to a user of the control platform.

Clause 19: The non-transitory computer-readable medium of any of Clauses 16-18, wherein the control platform is integrated into an enterprise system.

Clause 20: The non-transitory computer-readable medium of any of Clauses 16-19, wherein at least one of the user data prompt, the approved data prompt, or the response is textual data.

### ADDITIONAL CONSIDERATIONS

The preceding description is provided to enable any person skilled in the art to practice the various aspects or embodiments described herein. The examples discussed herein are not limiting of the scope, applicability, or aspects set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for securing and regulating user-AI interactions, comprising:
receiving, by a message broker of a control platform, a user data prompt to at least one AI system;
executing, by a secure layer of the control platform, a security control protocol on the user data prompt;
based on the executing, generating, by the secure layer of the control platform, an approved data prompt;
providing, via the message broker, the approved data prompt to the at least one AI system;
receiving, by the message broker, a response to the approved data prompt from the at least one AI system; and
providing, by the secure layer, the response to a user of the control platform.

2. The method of claim 1, wherein the executing of the security control protocol comprises applying, by a control module of the secure layer connected to the message broker, a data filtering scheme on the user data prompt.

3. The method of claim 1, wherein the executing of the security control protocol comprises classifying at least a portion of the user data prompt as sensitive.

4. The method of claim 1, wherein the executing of the security control protocol comprises running at least one internal AI model of the secure layer, connected to the message broker, on the user data prompt.

5. The method of claim 4, wherein the at least one internal AI model comprises at least one of a control AI model, a knowledge AI model, or a query AI model.

6. The method of claim 1, wherein the generating of the approved data prompt comprises at least one of blocking a portion of the user data prompt, filtering a portion of the user data prompt, masking a portion of the user data prompt, replacing at least a portion of the user data prompt with other data, or maintaining the user data prompt.

7. The method of claim 1, wherein the providing of the response comprises displaying the response, via a user interface on a display device.

8. The method of claim 1, further comprising generating an actionable notification to at least one of an administrator account or user account.

9. The method of claim 1, further comprising:
connecting the control platform to the at least one AI system;
based on the connecting, monitoring real-time communication activity between the control platform and the at least one AI system; and
presenting the at least one AI system as an interactive option via a user interface.

10. The method of claim 8, wherein the connecting of the control platform to the at least one AI system is undertaken via at least one API.

11. A processing system, comprising: a memory comprising computer-executable instructions; and a processor configured to execute the computer-executable instructions and cause the processing system to:
receive, a user data prompt to at least one AI system;
execute, a security control protocol on the user data prompt;
based on the execute, generate, an approved data prompt;
provide, the approved data prompt into the at least one AI system;
receive, a response to the approved data prompt from the at least one AI system; and
provide, the response to at least one account user of a control platform.

12. The processing system of claim 11, wherein the processor is further configured to cause the processing system to:
connect the control platform to the at least one AI system;
monitor real-time communication activity between the control platform and the at least one AI system; and
display the at least one AI system as an interactive option via a user interface.

13. The processing system of claim 11, wherein the causing of the processing system to execute the security control protocol, comprises causing the processing system to apply a data filtering scheme on the user data prompt, classify at least a portion of the user data prompt as sensitive, or run at least one internal AI model on the user data prompt.

14. The processing system of claim 13, wherein the at least one internal AI model comprises at least one of a control AI model, a knowledge AI model, or a query AI model.

15. The processing system of claim 11, wherein the causing of the processing system to generate the approved data prompt, comprises causing the processing system to block a portion of the user data prompt, filter a portion of the user data prompt, mask a portion of the user data prompt, replace at least a portion of the user data prompt with other data, or maintain the user data prompt.

16. A non-transitory computer-readable medium, storing program code for causing a processing system to perform a method comprising:
connecting, a control platform to at least one AI system;
based on the connecting, monitoring real-time communication activity between the control platform and the at least one AI system;
receiving, by a message broker of a control platform, a user data prompt to the at least one AI system;
executing, by a secure layer of the control platform, a security control protocol on the user data prompt;
based on the executing, generating, by the secure layer of the control platform, an approved data prompt;
providing, via the message broker, the approved data prompt to the at least one AI system; and
receiving, by the message broker, a response to the approved data prompt from the at least one AI system.

17. The non-transitory computer-readable medium of claim 16, wherein the method further comprises:
presenting the at least one AI system as an interactive option via a user interface.

18. The non-transitory computer-readable medium of claim 16, wherein the method further comprises:
providing, by the control platform, the response to a user of the control platform.

19. The non-transitory computer-readable medium of claim 16, wherein the control platform is integrated into an enterprise system.

20. The non-transitory computer-readable medium of claim 16, wherein at least one of the user data prompt, the approved data prompt, or the response is textual data.
